(19) United States
(12) Patent Application Publication
(10) Pub. No.: US 2025/0303366 A1
(43) Pub. Date: Oct. 2, 2025

(54) DIAGNOSTIC DEVICE, DIAGNOSTIC SYSTEM, DIAGNOSTIC METHOD, AND PROGRAM

(71) Applicant: ORGANO CORPORATION, Tokyo (JP)

(72) Inventors: Kenji SHIBASAKI, Tokyo (JP); Keisuke SASAKI, Tokyo (JP); Mayu ABE, Tokyo (JP); Yuri HOSHINO, Tokyo (JP); Masao HIDAKA, Tokyo (JP)

(73) Assignee: ORGANO CORPORATION, Tokyo (JP)

(21) Appl. No.: 18/859,780

(22) PCT Filed: Feb. 13, 2023
(86) PCT No.: PCT/JP2023/004774

§ 371 Date: Oct. 24, 2024

(30) Foreign Application Priority Data
Apr. 25, 2022 (JP) 2022-071416

(51) Int. Cl. B01D 65/10; B01D 61/48; C02F 1/469; G01M 99/00

(52) U.S. Cl. CPC B01D 65/10; B01D 61/48; C02F 1/4695; G01M 99/00; C02F 2209/445

(57) ABSTRACT

A measured value acquisition unit acquires measured values for each of a plurality of measurement items measured by one or more measuring instruments that measure the plurality of measurement items for an electrodeionization water production apparatus, a calculating unit calculates individual predicted product lifespans based on each of the measured values acquired by the measured value acquisition unit, a prediction unit predicts as the predicted product lifespan of the electrodeionization water production apparatus the shortest individual predicted product lifespan among a plurality of individual predicted product lifespans calculated by the calculation unit, and an output unit outputs information according to the predicted product lifespan predicted by the prediction unit.

### TECHNICAL FIELD

This invention relates to a diagnostic device, a diagnostic system, a diagnostic method and a program.

### BACKGROUND OF ART

A water treatment apparatus for improving water quality needs to be replaced after a defined period of use. For example, a device has been considered that predicts the date and time that the product lifespan of a water purification cartridge will be reached based on the amount of water passing through the water purification cartridge in a unit of time and that transmits a product lifespan signal before the date and time of the product lifespan is reached (see, for example, Patent Document 1).

PRIOR ART DOCUMENTS

### Patent Documents

Patent Document 1: JP 2018-202286 A

### SUMMARY OF THE INVENTION

### Problem to be Solved by the Invention

In the technology described above, the only measurement item for calculating the product lifespan of a water treatment apparatus is the water flow rate. Therefore, if the measured water flow rate increases for some reason, the time that the predicted product lifespan is reached will be later than the time when replacement is actually needed. In this case, a water treatment apparatus that needs to be replaced will continue to be used. In such cases, the desired quality will not be obtainable. Thus, there is a risk that an accurate replacement timing cannot be provided.

The purpose of the present invention is to provide a diagnostic device, a diagnostic system, a diagnostic method, and a program that can provide a more accurate replacement timing.

### Means for Solving the Problem

A diagnostic device of the invention is a diagnostic device that diagnoses an electrodeionization water production apparatus, comprising:

a measured value acquisition unit that acquires measured values for each of a plurality of measurement items measured by one or more measuring instruments that measure the plurality of measurement items for the electrodeionization water production apparatus;

a calculation unit that calculates individual predicted product lifespans based on each of the measured values acquired by the measured value acquisition unit;

a prediction unit that predicts as the predicted product lifespan of the electrodeionization water production apparatus the shortest individual predicted product lifespan among a plurality of individual predicted product lifespans calculated by the calculation unit; and

an output unit that outputs information according to the predicted product lifespan predicted by the prediction unit.

A diagnostic system of the present invention also comprises:
an electrodeionization water production apparatus;
one or more measuring instruments that measure multiple measurement items for the electrodeionization water production apparatus; and
a diagnostic device,
the diagnostic device comprising:
   a measured value acquisition unit that acquires measured values measured by the measuring instruments;
   a calculation unit that calculates individual predicted product lifespans based on each of the measured values acquired by the measured value acquisition unit;
   a prediction unit that predicts as the predicted product lifespan of the electrodeionization water production apparatus the shortest individual predicted product lifespan among a plurality of individual predicted product lifespans calculated by the calculation unit; and
   an output unit that outputs information according to the predicted product lifespan predicted by the prediction unit.

In addition, a diagnostic method of the present invention is a diagnostic method for diagnosing an electrodeionization water production apparatus, the method comprising:

a process for acquiring measured values measured by one or more measuring instruments for each of a plurality of measurement items for the electrodeionization water production apparatus;

a process for calculating individual predicted product lifespans based on each of the acquired measured values;

a process for predicting as the predicted product lifespan of the electrodeionization water production apparatus the shortest individual predicted product lifespan among a plurality of calculated individual predicted product lifespans; and

a process for displaying information on a display unit according to the predicted product lifespan.

In addition, a program of the present invention is a program for causing a computer to execute procedures, the procedures comprising:

a procedure for acquiring measured values measured by one or more measuring instruments for each of a plurality of measurement items for an electrodeionization water production apparatus;

a procedure for calculating individual predicted product lifespans based on each of the acquired measured values;

a procedure for predicting as the predicted product lifespan of the electrodeionization water production apparatus the shortest individual predicted product lifespan among a plurality of calculated individual predicted product lifespans; and

a procedure for displaying information on a display unit according to the predicted product lifespan.

### Advantageous Effects of the Invention

In the present invention, a more accurate replacement timing can be provided.

### BRIEF DESCRIPTION OF THE DRAWINGS

FIG. 1 is a diagram showing a first embodiment of the diagnostic system of the present invention.

FIG. 2 is a diagram showing an example of the components provided in the diagnostic device shown in FIG. 1.

FIG. 3 is a diagram showing an example of the individual predicted product lifespans for each measurement item calculated by the calculation unit shown in FIG. 2.

FIG. 4 is a diagram showing an example of the display style in which the output unit shown in FIG. 2 displays information according to the predicted product lifespan.

FIG. 5 is a diagram showing another example of the display style in which the output unit shown in FIG. 2 displays information according to the predicted product lifespan.

FIG. 6 is a flowchart illustrating an example of a diagnostic method for the electrodeionization water production apparatus in the diagnostic device shown in FIG. 1.

FIG. 7 is a diagram showing a second embodiment of a diagnostic system of the present invention.

FIG. 8 is a diagram showing an example of the components provided in the diagnostic device shown in FIG. 7.

FIG. 9 is a graph showing an example of the change in measured values versus operation time for two measurement items.

FIG. 10 is a flowchart illustrating an example of a diagnostic method for the electrodeionization water production apparatus in the diagnostic device shown in FIG. 7.

### DESCRIPTION OF THE EMBODIMENTS

Embodiments of the invention are next described with reference to the drawings.

### First Embodiment.

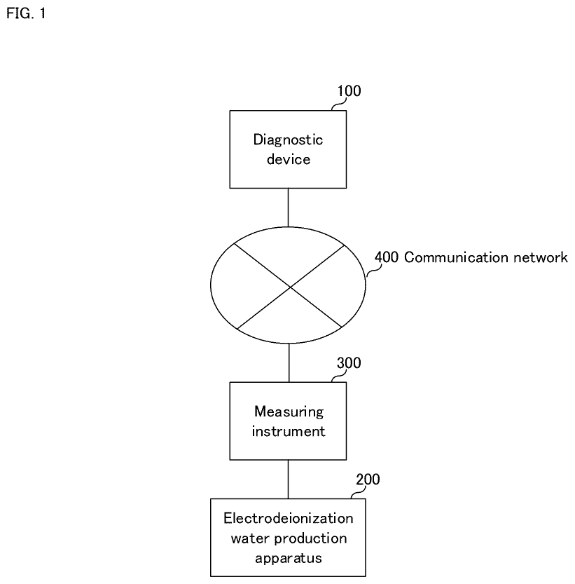

FIG. 1 is a diagram showing a first embodiment of a diagnostic system of the present invention. As shown in FIG. 1, the diagnostic system in this embodiment has diagnostic device 100, electrodeionization water production apparatus 200, and measuring instrument 300. Diagnostic device 100 and measuring instrument 300 are communicably connected via communication network 400. Communication network 400 can be the general Internet. Alternatively, communication network 400 may be a closed communication network limited to a specific location, such as an intracompany network. Diagnostic device 100 and measuring instrument 300 may be directly connected to each other.

Electrodeionization (EDI) water production apparatus 200 is an apparatus that produces pure water by the force of electricity by transferring ions contained in water treated by, for example, a reverse osmosis membrane. Electrodeionization water production apparatus 200 can be commonly used in the process of producing pure water.

Measuring instrument 300 measures multiple measurement items simultaneously for electrodeionization water production apparatus 200. For example, measuring instrument 300 measures at least two of the following as multiple measurement items: the integrated amount of electricity supplied to electrodeionization water production apparatus 200, the differential pressure of the water supplied to electrodeionization water production apparatus 200, the voltage applied to the electrodes in electrodeionization water production apparatus 200, the water quality of the treated water supplied through electrodeionization water production apparatus 200, the integrated load of treated water supplied through electrodeionization water production apparatus 200, and the integrated amount of water supplied through electrodeionization water production apparatus 200. Measuring instrument 300 transmits the measured values to diagnostic device 100. Measuring instrument 300 transmits identification information that can identify measuring instrument 300 together with the measured values. If measurement instrument 300 is capable of identifying electrodeionization water production apparatus 200 that is the target of the measurement, identification information that can identify electrodeionization water production apparatus 200 that is the target of the measurement may be transmitted with the measured values. In addition, measuring instrument 300 adds to the measurement value day information indicating the measurement date and time of the measurement value to be transmitted and transmits it. A single measuring instrument 300 may measure multiple measurement items. Alternatively, multiple measuring instruments for the multiple measurement items may each measure respective items of the multiple measurement items. The number of measuring instruments 300 may be one or more than one. When multiple measuring instruments 300 are provided, each measuring instrument may measure all or some of the multiple measurement items, or each measuring instrument may measure a respective measurement items assigned to that measuring instrument.

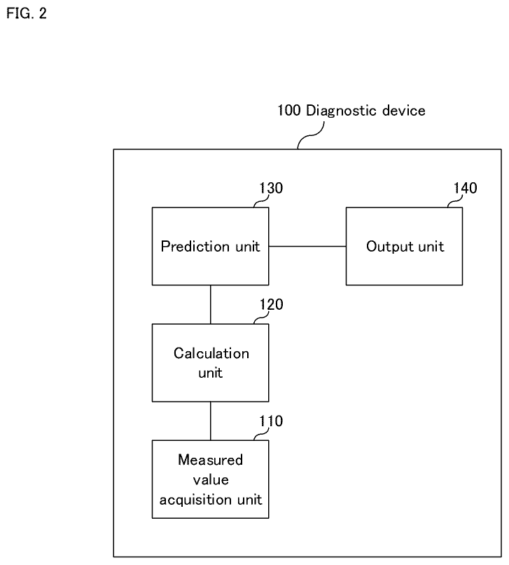

Diagnostic device 100 acquires the measured values transmitted from measuring instrument 300. Diagnostic device 100 diagnoses the product lifespan of electrodeionization water production apparatus 200 based on the acquired measured values. FIG. 2 is a diagram showing an example of the components provided in diagnostic device 100 shown in FIG. 1. As shown in FIG. 2, diagnostic device 100 shown in FIG. 1 includes measured value acquisition unit 110, calculation unit 120, prediction unit 130, and output unit 140. FIG. 2 shows, of diagnostic device 100 shown in FIG. 1, only the major components that are relevant to this embodiment.

Measured value acquisition unit 110 acquires the measured values for each of the plurality of measurement items transmitted from measuring instrument 300. Measured value acquisition unit 110 may issue a request to measuring instrument 300 to acquire the measured values.

Calculation unit 120 calculates individual predicted product lifespans based on each of the measured values acquired by measured value acquisition unit 110. Calculation unit 120 maintains in advance a mapping between measured values and individual predicted product lifespans for each of the multiple measurement items. Calculation unit 120 may acquire individual predicted product lifespans that are associated with the measured values acquired by measured value acquisition unit 110. Calculation unit 120 may calculate the individual predicted product lifespans based on the measured values acquired by measured value acquisition unit 110 by using the actual values of the relationships between product lifespans and measured values measured in the past. This calculation method is not specified. Calculation unit 120 outputs the calculated individual predicted product lifespans to prediction unit 130. At this time, calculation unit 120 may also output the measurement items for which the individual predicted product lifespans are calculated to prediction unit 130 along with the individual predicted product lifespans.

It has been reported that the catalyst coating layer of oxide-coated electrodes delaminates as the current continues to flow through the electrodes. If the catalyst layer is consumed, it may cause a sudden rise in voltage and render operation impossible. Therefore, the integrated amount of energization is used as a measurement item for calculation unit 120 to calculate an individual predicted product lifespan. In some cases, the inflow of oxidants and foreign matter into electrodeionization water production apparatus 200 causes poor water flow and increases the water flow differential pressure. An increase in the water flow differential pressure may cause a decrease in the quality of the treated water and a decrease in the flow rate of the treated water. Higher internal pressure also increases the risk of leakage. Therefore, the water flow differential pressure is used as a measurement item for calculation unit 120 in calculating an individual predicted product lifespan. The voltage applied to the electrodes increases mainly due to damage to the ion exchanger caused by the electric current, electrode plates (peeling of the catalyst layer), and scale generation (water quality and operating conditions of the treated water supplied to electrodeionization water production apparatus 200). If the voltage applied to the electrodes increases and exceeds the capacity of the DC power supply, the current value decreases and the quality of the treated water declines.

Therefore, the voltage applied to the electrodes is used as a measurement item for calculation unit 120 in calculating an individual predicted product lifespan. In addition, there is a risk that components that impede the exchange of ions may accumulate inside electrodeionization water production apparatus 200 due to long-term operation. Such components include, for example, multivalent metal ions such as hardness components that are present in a certain percentage of RO (reverse osmosis) permeate. Many of these components have high selectivity coefficients for ion exchange resins. The amount of these components that have accumulated is an integrated accumulated amount, The integrated load, which is calculated based on conductivity, flow rate, and various ion concentrations, can be used as an indicator for ascertaining the integrated accumulated amount. If the integrated load increases, the integrated load may affect the quality of the treated water, the voltage values, the differential pressure, and so on. Therefore, the integrated load of the treated water flowing through electrodeionization water production apparatus 200 is used as a measurement item for calculation unit 120 in calculating an individual predicted product lifespan.

Prediction unit 130 predicts as the predicted product lifespan the shortest individual predicted product lifespan among the multiple individual predicted product lifespans calculated by calculation unit 120. It goes without saying that the individual predicted product lifespans whose lengths are compared with each other are individual predicted product lifespans that depend on the measured values taken by measuring instruments 300 at the same time for multiple measurement items.

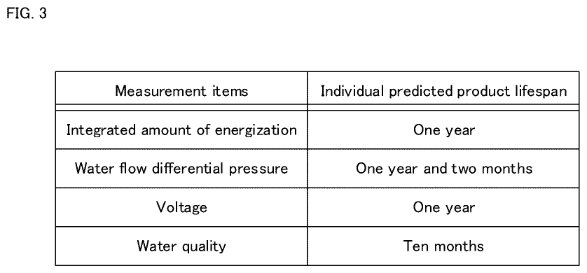

FIG. 3 is a diagram showing an example of the individual predicted product lifespans for each measurement item calculated by calculation unit 120 shown in FIG. 2. Prediction unit 130 predicts as the predicted product lifespan the shortest individual predicted product lifespan by referring to the results of the individual predicted product lifespans calculated by calculation unit 120 for each measurement item as shown in FIG. 3. In the example shown in FIG. 3, the individual predicted product lifespan of “ten months” for the measurement item “water quality” is the shortest. Prediction unit 130 consequently predicts “ten months” as the predicted product lifespan of electrodeionization water production apparatus 200 that is the object of measurement.

Prediction unit 130 may predict as the predicted lifetime product lifespan the shorter of the shortest individual predicted product lifespan described above and a period obtained by subtracting the period that begins with the start of operation of electrodeionization water production apparatus 200 and ends when measuring instrument 300 measures multiple measurement items from the usable period that has been set in advance for electrodeionization water production apparatus 200 (hereinafter referred to as the remaining usable period). The operation time (the period beginning with the start of operation of electrodeionization water production apparatus 200 and ending when measuring instrument 300 measures multiple measurement items) can be calculated (predicted) based on the integrated amount of water that has flowed through electrodeionization water production apparatus 200. Therefore, prediction unit 130 may calculate (predict) the remaining usable period based on the integrated amount of water that has flowed through electrodeionization water production apparatus 200. This remaining usable period can be used as a numerical value that indicates the degree of deterioration with age of the components that make up electrodeionization water production apparatus 200. In other words, the remaining usable period can be used for considering the expected product lifespan of the components that make up electrodeionization water production apparatus 200 as they deteriorate over time. For example, plastics used as components of electrodeionization water production apparatus 200 deteriorate with use and lose strength due to ultraviolet rays and other factors.

Output unit 140 outputs information according to the predicted product lifespan predicted by prediction unit 130. Output unit 140 may output the result of comparing the predicted product lifespan predicted by prediction unit 130 with a preset threshold value. Output unit 140 may output the predicted product lifespan predicted by prediction unit 130. Output unit 140 may also output the time (e.g., year and month) of reaching the predicted product lifespan based on the predicted product lifespan predicted by prediction unit 130. The output mode of the information according to the predicted product lifespan of output unit 140 can be by displaying the information, lighting a lamp according to the information, printing, sound output, or transmitting the information to other devices.

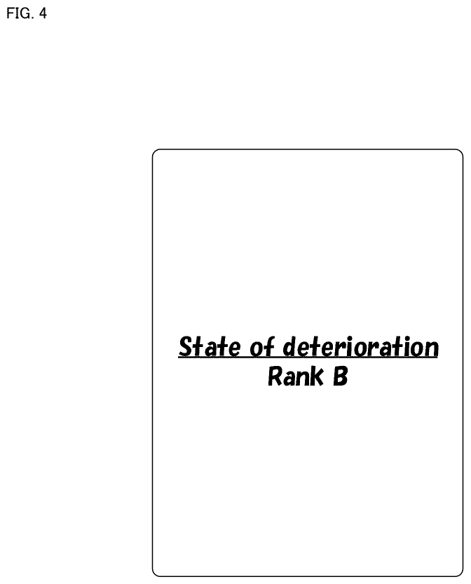

FIG. 4 is a diagram showing an example of the display style in which output unit 140 shown in FIG. 2 displays information according to the predicted product lifespan. As shown in FIG. 4, output unit 140 shown in FIG. 2 may display rank information of the state of deterioration according to the predicted product lifespan predicted by prediction unit 130. The rank of this state of deterioration can be based on the results of the comparison between the predicted product lifespan predicted by prediction unit 130 and the multiple threshold values by output unit 140. For example, if the predicted product lifespan is longer than threshold A, output unit 140 may rank the degradation state as rank A. If the predicted product lifespan is less than threshold A and greater than threshold B, which is shorter than threshold A, output unit 140 may rank the state of deterioration as rank B. If the predicted product lifespan is less than threshold B, output unit 140 may also rank the state of deterioration as rank C.

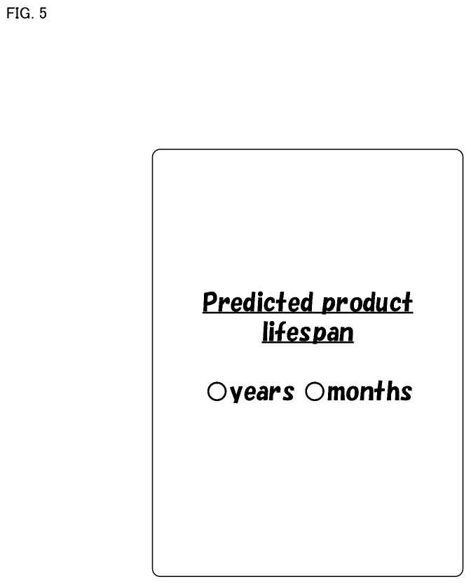

FIG. 5 is a diagram showing another example of the display style in which output unit 140 shown in FIG. 2 displays information according to the predicted product lifespan. As shown in FIG. 5, output unit 140 shown in FIG. 2 may display the predicted product lifespan itself as predicted by prediction unit 130.

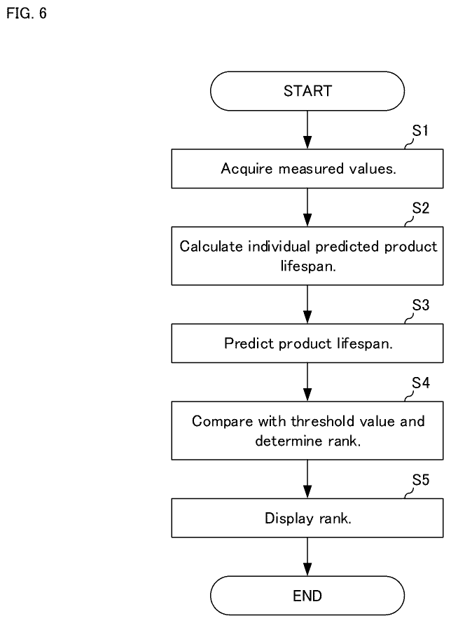

The method of diagnosing electrodeionization water production apparatus 200 in diagnostic device 100 shown in FIG. 1 is next described. FIG. 6 is a flowchart illustrating an example of a diagnostic method for electrodeionization water production apparatus 200 in diagnostic device 100 shown in FIG. 1. The following is an example of a case in which output unit 140 displays information on the deterioration of electrodeionization water production apparatus 200 as a rank.

When operation using electrodeionization water production apparatus 200 is started and the measured values for multiple measurement items measured by measuring instrument 300 are transmitted to diagnostic device 100 at a predetermined timing, measured value acquisition unit 110 acquires the multiple measured values that have been transmitted (Step S1). Calculation unit 120 then calculates the individual predicted product lifespans based on each of the measured values acquired by measured value acquisition unit 110 (Step S2). The calculation method for individual predicted product lifespans is as described above. Prediction unit 130 then predicts as the predicted product lifespan the shortest individual predicted product lifespan among the multiple individual predicted product lifespans calculated by calculation unit 120 (Step S3).

Output unit 140 compares the predicted product lifespan predicted by prediction unit 130 with the threshold value and determines a rank as deterioration information for electrodeionization water production apparatus 200 based on the relationship between the predicted product lifespan and the threshold value (Step S4). The method of determining ranks can be the method described above. Output unit 140 then displays the determined rank information (Step S5).

Thus, in this embodiment, measuring instrument 300 measures multiple measurement items for electrodeionization water production apparatus 200. Diagnostic device 100 calculates individual predicted product lifespans based on each of the multiple measured values. Diagnostic device 100 predicts the shortest individual predicted product lifespan among the calculated individual predicted product lifespans as the predicted product lifespan. This can present a more accurate replacement time for electrodeionization water production apparatus 200. It can also present the replacement time for each of electrodeionization water production apparatuses 200 in operation. Furthermore, the schedule for providing electrodeionization water production apparatus 200 can be easily managed.

### Second Embodiment

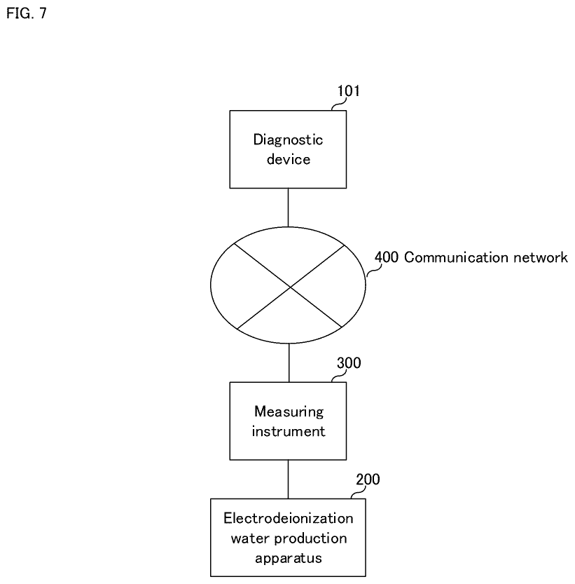

FIG. 7 is a diagram showing a second embodiment of the diagnostic system of the present invention. As shown in FIG. 7, the diagnostic system in this embodiment has diagnostic device 101, electrodeionization water production apparatus 200, and measuring instrument 300. Diagnostic device 101 and measuring instrument 300 are communicably connected via communication network 400. Electrodeionization water production apparatus 200, measuring instrument 300, and communication network 400 are each the same as those in the first embodiment. Diagnostic device 101 and measuring instrument 300 may be directly connected to each other.

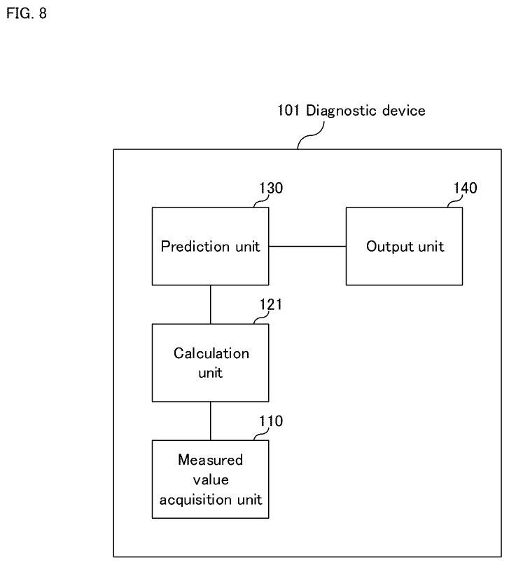

Diagnostic device 101 acquires the measured values transmitted from measuring instruments 300. Diagnostic device 101 diagnoses the product lifespan of electrodeionization water production apparatus 200 based on the acquired measured values. FIG. 8 is a diagram showing an example of the components of diagnostic device 101 shown in FIG. 7. As shown in FIG. 8, diagnostic device 101 has measured value acquisition unit 110, calculation unit 121, prediction unit 130, and output unit 140. Measured value acquisition unit 110, prediction unit 130, and output unit 140 are each the same as the respective components in the first embodiment. FIG. 8 shows only the major components of diagnostic device 101 shown in FIG. 7 that are relevant to this embodiment.

Calculation unit 121 calculates individual predicted product lifespans based on each of the measured values acquired by measured value acquisition unit 110. Calculation unit 121 calculates the individual predicted product lifespans based on first measured values and the rate of change over time of the first measured values that are the most recent measurements of each of the plurality of measurement items and second measured values that were measured immediately before the first measured values. In other words, calculation unit 121 calculates the individual predicted product lifespans based on the first measured values and the trend over time from the second measured values to the first measured values. The most recent measurement is at the time that is temporally prior to the time at which calculation unit 121 calculates the trend and, of the times at which the measured values are acquired by measured value acquisition unit 110, is the time that is closest to the time at which calculation unit 121 calculates the trend. The immediately preceding time is a time before the time of the first measured values that were used by calculation unit 121 to calculate the trend, and, of the times at which measured value acquisition unit 110 acquired the first measured values, is the time that is closest to the time at which measured value acquisition unit 110 acquired the first measured values. The time range between the times at which the two measured values were taken, which is used by calculation unit 121 to calculate the trend of the measured values with respect to the unit time at the times of measurement, may be other than what is described above and is not particularly limited. For example, calculation unit 121 may calculate the rate of change over time using two measured values acquired by measured value acquisition unit 110 at different times from each other for each of the plurality of measurement items and may then calculate the individual predicted product lifespans based on the calculated rate of change (as in the following explanation). The time range can be, for example, a predetermined period of time between the time of measurement of the first measured values and the time of measurement of the second measured values. The relationship between the trend (change in measured values over unit time) and the predicted product lifespans differs depending on the measurement item. Therefore, calculation unit 121 uses the relationships between the trends and product lifespans measured in the past for each measurement item to calculate the individual predicted product lifespans based on the measured values acquired by measured value acquisition unit 110 and their trends. Calculation unit 121 outputs the calculated individual predicted product lifespans to prediction unit 130. At this time, calculation unit 121 may also output to prediction unit 130 the measurement items for which the individual predicted product lifespans were calculated along with the individual predicted product lifespans.

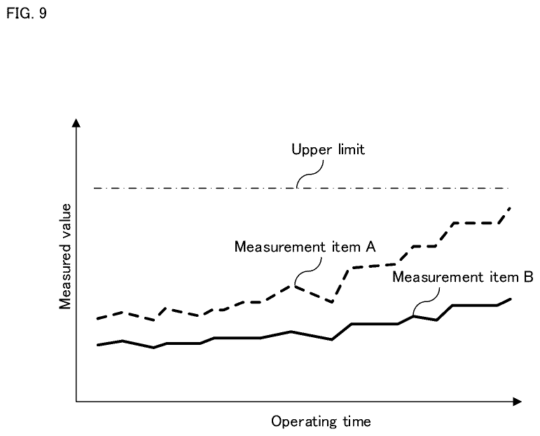

FIG. 9 is a graph showing an example of the change of measured values with respect to operation time for two measurement items. As shown in FIG. 9, the point in time at which a measured value reaches its upper limit, i.e., the time when electrodeionization water production apparatus 200 is expected to reach the end of its product lifespan, often depends not only on the measured value at the time of measurement but also on the measurement items (measurement items A and B shown in FIG. 9) and on the change (trend) of the measured value relative to unit time during measurement. Therefore, in this embodiment, calculation unit 121 uses the relationships between the trends and product lifespans measured in the past for each measurement item to calculate the individual predicted product lifespans based on the measured values acquired by measured value acquisition unit 110 and their trends.

Calculation unit 121 calculates the product lifespans according to the calculated values for each measurement item. Calculation unit 121 may calculate the individual predicted product lifespans based on the calculated product lifespans and the rate of change (trend) of the product lifespans over time. Specifically, calculation unit 121 calculates an individual predicted product lifespan (first product lifespan) for each measurement item according to the most recently measured first measured value. Calculation unit 121 calculates an individual predicted product lifespan (second product lifespan) according to the second measured value that was measured immediately before the first measured value. Calculation unit 121 calculates the rate (trend) of the change from the second product lifespan to the first product lifespan with respect to the time from the date and time when the second measured value was measured to the date and time when the first measured value was measured. Calculation unit 121 then calculates the individual predicted product lifespan based on the calculated trend and the first product lifespan. The method for calculating the individual predicted product lifespans from each of the measured values may also be the same as the method used in the first embodiment.

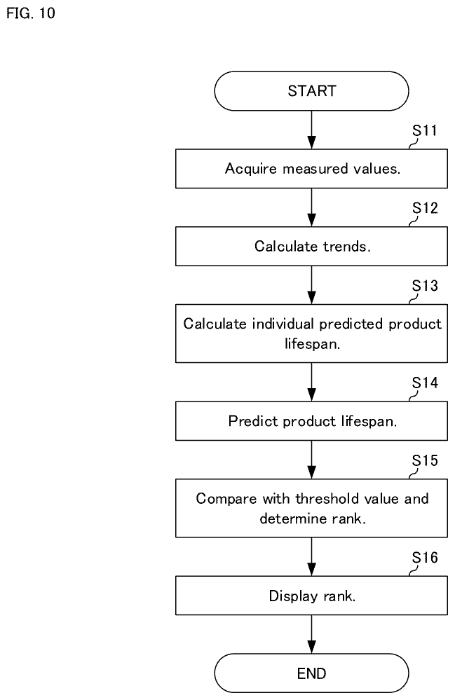

The method of diagnosing electrodeionization water production apparatus 200 in diagnostic device 101 shown in FIG. 7 is next described. FIG. 10 is a flowchart illustrating an example of the diagnostic method for electrodeionization water production apparatus 200 in the diagnostic device shown in FIG. 7. An example of a case is next described in which output unit 140 displays information regarding the deterioration of electrodeionization water production apparatus 200 as a rank.

When operation using electrodeionization water production apparatus 200 is started and the measured values for the plurality of measurement items measured by measuring instrument 300 are transmitted to diagnostic device 101 at a predetermined timing, measured value acquisition unit 110 acquires the multiple measured values that have been transmitted (Step S11). Calculation unit 121 then calculates the rate of the change of the first measured values that were most recently acquired by measured value acquisition unit 110 with respect to the time from the second measured values acquired by measured value acquisition unit 110 immediately before the first measured values, that is, the trend of the measurement values with respect to unit time at the time of measurement (Step S12). Calculation unit 121 then calculates the individual predicted product lifespans based on the measured values and trends for the relevant measurement items (Step S13). Prediction unit 130 then predicts as the predicted product lifespan the shortest individual predicted product lifespan among the multiple individual predicted product lifespans calculated by calculation unit 121 (Step S14).

Output unit 140 compares the predicted product lifespan predicted by prediction unit 130 with the threshold value and determines a rank as the deterioration information for electrodeionization water production apparatus 200 based on the relationship between the predicted product lifespan and the threshold value (Step S15). The method of determining ranks can be the method previously described. Output unit 140 then displays the determined rank information Step S16).

Thus, in this embodiment, measuring instrument 300 measures multiple measurement items for electrodeionization water production apparatus 200. Diagnostic device 101 calculates the individual predicted product lifespans based on each of the multiple measurements taken. Diagnostic device 101 predicts the shortest individual predicted product lifespan among the calculated individual predicted product lifespans as the predicted product lifespan. When calculation unit 121 calculates the individual predicted product lifespans, the rate of change (trend) in the measured values over unit time is used to calculate the individual predicted product lifespans. This method can provide an even more accurate replacement time for electrodeionization water production apparatus 200. This method can also provide the replacement time for each of electrodeionization water production apparatuses 200 in operation. Furthermore, the schedule for providing electrodeionization water production apparatuses 200 can be easily managed.

Although the invention has been described above by assigning each function (process) to a respective constituent element, these assignments are not limited to those described above. In addition, regarding the configuration of the constituent elements, the above-described embodiment is merely an example, and the present invention is not limited thereto. Further, the present invention may be a combination of the embodiments.

The processing performed by each of the above-described diagnostic devices 100 and 101 may be performed by logic circuits manufactured according to the purpose. Further, a computer program (hereinafter, referred to as a “program”) in which the processing contents are described as procedures may be recorded on a recording medium that can be read by diagnostic devices 100 and 101, and the program recorded on the recording medium may be read into and executed by diagnostic devices 100 and 101. The recording medium that can be read by diagnostic devices 100 and 101 may refer to a memory such as ROM (Read Only Memory), RAM (Random Access Memory), an HDD (Hard Disc Drive), an SSD (Solid State Drive), or the like that is incorporated in diagnostic devices 100 and 101, or may further refer to a transferable recording medium such as a magneto-optical disk, a DVD (Digital Versatile Disc), a CD (Compact Disc), a Blu-ray (registered trademark) Disc, or a USB (Universal Serial Bus) memory. The program recorded on the recording medium is read by a CPU provided in each of diagnostic devices 100 and 101, and the same processing as that described above is performed under the control of the CPU. Here, the CPU operates as a computer that executes a program read from a recording medium on which the program is recorded.

While the present invention has been described above with reference to embodiments, the present invention is not limited to the above embodiments. Various changes within the scope of the present invention that will be understood by those skilled in the art can be made in the configuration and details of the present invention.

This application claims priority based on JP 2022-071416 filed on Apr. 25, 2022, all disclosures of which are incorporated herein.

1. A diagnostic device that diagnoses an electrodeionization water production apparatus, comprising:
a measured value acquisition unit that acquires measured values for each of a plurality of measurement items measured by one or more measuring instruments that measure the plurality of measurement items for the electrodeionization water production apparatus;
a calculation unit that calculates individual predicted product lifespans based on each of the measured values acquired by the measured value acquisition unit;
a prediction unit that predicts as the predicted product lifespan of the electrodeionization water production apparatus the shortest individual predicted product lifespan among a plurality of individual predicted product lifespans calculated by the calculation unit; and
an output unit that outputs information according to the predicted product lifespan predicted by the prediction unit.

2. The diagnostic device according to claim 1, wherein
the calculation unit calculates the individual predicted product lifespans based on the rate of change over time of measured values for the plurality of measurement items.

3. The diagnostic device according to claim 1, wherein:
the prediction unit predicts as the predicted lifetime product lifespan the shorter of the shortest individual predicted product lifespan and a period obtained by subtracting a period beginning at the start of operation of the electrodeionization water production apparatus to the time when the measuring instrument measures multiple measurement items from a usable period for the electrodeionization water production apparatus.

4. The diagnostic device according to claim 1, wherein:
the measured value acquisition unit acquires the measured values measured by the measuring instruments for at least two of the following multiple measurement items: the integrated amount of electricity supplied to the electrodeionization water production apparatus, the differential pressure of the water supplied to the electrodeionization water production apparatus, the voltage applied to the electrodes in the electrodeionization water production apparatus, the water quality of treated water supplied through the electrodeionization water production apparatus, the integrated load of treated water supplied through the electrodeionization water production apparatus, and the integrated amount of water supplied through the electrodeionization water production apparatus.

5. The diagnostic device according to claim 1, wherein:
the output unit outputs the results of comparing the predicted product lifespan with a threshold value.

6. A diagnostic system, comprising:
an electrodeionization water production apparatus;
one or more measuring instruments that measure multiple measurement items for the electrodeionization water production apparatus; and
a diagnostic device, comprising:
a measured value acquisition unit that acquires measured values measured by the measuring instruments;
a calculation unit that calculates individual predicted product lifespans based on each of the measured values acquired by the measured value acquisition unit;
a prediction unit that predicts as the predicted product lifespan of the electrodeionization water production apparatus the shortest individual predicted product lifespan among a plurality of individual predicted product lifespans calculated by the calculation unit; and
an output unit that outputs information according to the predicted product lifespan predicted by the prediction unit.

7. A diagnostic method for diagnosing an electrodeionization water production apparatus, the method comprising:
acquiring measured values measured by one or more measuring instruments for each of a plurality of measurement items for the electrodeionization water production apparatus;
calculating individual predicted product lifespans based on each of the acquired measured values;
predicting as the predicted product lifespan of the electrodeionization water production apparatus the shortest individual predicted product lifespan among a plurality of calculated individual predicted product lifespans; and
displaying information on a display unit according to the predicted product lifespan.

8. A recording medium that records a program for causing a computer to execute procedures, the procedures comprising:
acquiring measured values measured by one or more measuring instruments for each of a plurality of measurement items for an electrodeionization water production apparatus;
calculating individual predicted product lifespans based on each of the acquired measured values;
predicting as the predicted product lifespan of the electrodeionization water production apparatus the shortest individual predicted product lifespan among a plurality of calculated individual predicted product lifespans; and
displaying information on a display unit according to the predicted product lifespan.
